(19) United States
(12) Patent Application Publication
(10) Pub. No.: US 2013/0033119 A1
(43) Pub. Date: Feb. 7, 2013

(54) METHODS AND SYSTEMS FOR REDUCING LEAKAGE CURRENT

(71) Applicant: Stephen A. Zavodny, Fort Wayne, IN (US)

(72) Inventor: Stephen A. Zavodny, Fort Wayne, IN (US)

(21) Appl. No.: 13/197,390

(22) Filed: Aug. 3, 2011

(51) Int. Cl. H02J 3/01

(52) U.S. Cl. 307/105

(57) ABSTRACT

A filter circuit configured for coupling a power supply and a motor controller is described. The filter circuit includes at least one filter capacitor positioned between the power supply and the motor controller. The filter circuit also includes at least one switching device coupled to the power supply and configured to selectively couple the power supply to the motor controller and/or the at least one filter capacitor to a ground conductor.

### BACKGROUND OF THE INVENTION

The embodiments described herein relate generally to electric motors, and more specifically, to reducing earth ground leakage current without reducing an effectiveness of an electrical magnetic interference (EMI) filter.

EMI is an electrical noise current which is usually present in the radio-wave frequency range. This current originates from within a system of electrical devices rather than from an outside source such as a radio signal transmitter. Electric power supplies are known to be significant generators of EMI. In connection with electric power supplies, EMI is undesirable because, for example, it can disturb the operation or degrade the performance of other equipment connected to the same source of power.

In a typical power supply, EMI filtering incorporates a “Y” capacitor (Y-cap) circuit which is permanently connected to a power supply ground within a housing of the power supply. This configuration allows the capacitor to be located very close to the electrical ground, thereby optimizing EMI suppression. For example, Y-caps typically connect near a power supply's input terminals and terminate at electrical ground. By diverting common-mode current to electrical ground, undesirable electrical noise current can be suppressed, thereby preventing EMI from leaving the power supply via its input terminals and disturbing other equipment electrically connected to the same source of power. However, the internally mounted Y-caps of conventional power supplies are difficult to disconnect from the power supply ground.

For a variety of reasons, some power supply end-users do not want a Y-cap circuit permanently connected to the power supply ground. For example, a drawback in using a Y-cap circuit for EMI suppression is an attendant “leakage current” which flows into the electrical ground. For instance, whenever an alternating current (AC) voltage is applied across a Y-cap circuit, some amount of current will “leak” through the Y-cap circuit to electrical ground.

### BRIEF DESCRIPTION OF THE INVENTION

In one aspect, a filter circuit configured for coupling a power supply and a motor controller is provided. The filter circuit includes at least one filter capacitor positioned between the power supply and the motor controller. The filter circuit also includes at least one switching device coupled to the power supply and configured to selectively couple the power supply to the motor controller and/or the at least one filter capacitor to a ground conductor.

In another aspect, an electric motor configured to be powered by a power supply is provided. The motor includes a motor controller and a filter circuit coupled between the power supply and the motor controller. The filter circuit includes at least one filter capacitor and is configured to selectively couple the power supply to the motor controller and/or the at least one filter capacitor to a ground conductor.

In yet another aspect, a method for reducing leakage current in an electric motor system that includes a power supply, at least one filter capacitor, and an electric motor is provided. The method includes determining if power is present at a first line conductor of the power supply and a second line conductor of the power supply. The method also includes disconnecting at least one of the power supply from the motor controller, and the at least one filter capacitor from a ground conductor, when power is not present at the first line conductor and the second line conductor.

### BRIEF DESCRIPTION OF THE DRAWINGS

FIG. 1 is a block diagram of an exemplary motor control system that includes a filter circuit.

FIG. 2 is a block diagram of an exemplary filter circuit that may be included within the motor control system shown in FIG. 1.

FIG. 3 is a circuit diagram of a first alternative filter circuit that may be included within the motor control system shown in FIG. 1.

FIG. 4 is a circuit diagram of a second alternative filter circuit that may be included within the motor control system shown in FIG. 1.

FIG. 5 is a circuit diagram of a third alternative filter circuit that may be included within the motor control system shown in FIG. 1.

FIG. 6 is a circuit diagram of a switching device and power conditioning device that may be included within the filter circuits shown in FIGS. 3-5.

FIG. 7 is a circuit diagram of a fourth alternative filter circuit that may be included within the motor control system shown in FIG. 1.

FIG. 8 is a flow chart of an exemplary method for reducing leakage current in the motor control system shown in FIG. 1.

### DETAILED DESCRIPTION OF THE INVENTION

The methods and systems described herein facilitate reducing an earth ground fault leakage current flowing through a filter circuit while also providing electromagnetic interference (EMI) protection to the motor drive controller. The leakage current is reduced or eliminated by either disconnecting the motor drive controller from a power source or disconnecting a ground of the filter circuit from earth ground.

Technical effects of the methods, systems, and apparatus described herein include at least one of: (a) determining if power is present at a first line conductor of the power supply and a second line conductor of the power supply; and (b) disconnecting at least one of the power supply from the motor controller, and the at least one filter capacitor from a ground conductor, when power is not present at the first line conductor and the second line conductor.

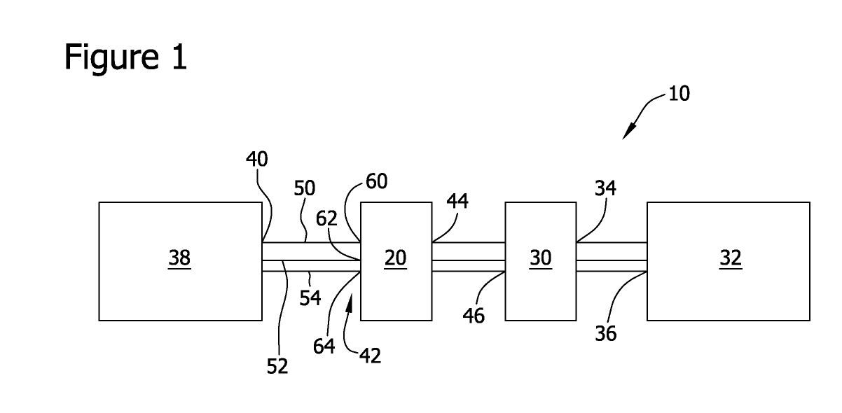

FIG. 1 is a block diagram of an exemplary embodiment of a motor control system 10 that includes a filter circuit 20. Filter circuit 20 may include, but is not limited to, an EMI filter circuit. In the exemplary embodiment, motor control system 10 includes a motor controller 30 coupled to an electric motor 32. Although illustrated as separate components, motor controller 30 and electric motor 32 may be included within a single housing. Motor controller 30 provides electric motor 32 with operating signals, for example, but not limited to, a sine wave operating signal, a square wave operating signal, or any other suitable operating signal that allows system 10 to function as described herein. The operating signals direct operation of electric motor 32.

In the exemplary embodiment, motor control system 10 also includes a power supply 38. In the exemplary embodiment, power supply 38 is a one-hundred and twenty volt alternating current (AC) power supply, a two-hundred and forty volt AC power supply, or any other suitable power supply that allows system 10 to function as described herein. An output power line 40 of power supply 38 is coupled to an input 42 of filter circuit 20 and an output 44 of filter circuit 20 is coupled to an input 46 of motor controller 30. In the exemplary embodiment, motor controller 30 converts the AC voltage from power supply 38 to a direct current (DC) voltage used to drive electric motor 32. In the exemplary embodiment, output power line 40 includes three conductors: a first line conductor 50, a second line conductor 52, and a ground conductor 54. In some embodiments, first line conductor 50 is referred to as L1 and second line conductor 52 is referred to as L2 or a neutral conductor. Ground conductor 54 is typically coupled to earth ground. However, ground conductor 54 may be coupled to a chassis ground or any other grounding that allows system 10 to function as described herein.

In the exemplary embodiment, filter circuit 20 is configured to condition electricity provided to motor controller 30 via power line 40. For example, filter circuit 20 may suppress EMI within system 10. EMI is defined generally as any undesirable electromagnetic emission or any electrical electronic disturbance, man-made or neutral, which causes an undesirable response, malfunctioning or degradation in the performance of electrical equipment.

In the exemplary embodiment, input 42 of filter circuit 20 includes a first AC line input terminal 60 for coupling filter circuit 20 to first line conductor 50. Input 42 also includes a second AC line input terminal 62 for coupling filter circuit 20 to second line conductor 52. Furthermore, input 42 includes a ground terminal 64 for coupling filter circuit 20 to ground conductor 54. In some embodiments, second AC line input terminal 62 may also be referred to as neutral line input terminal 62.

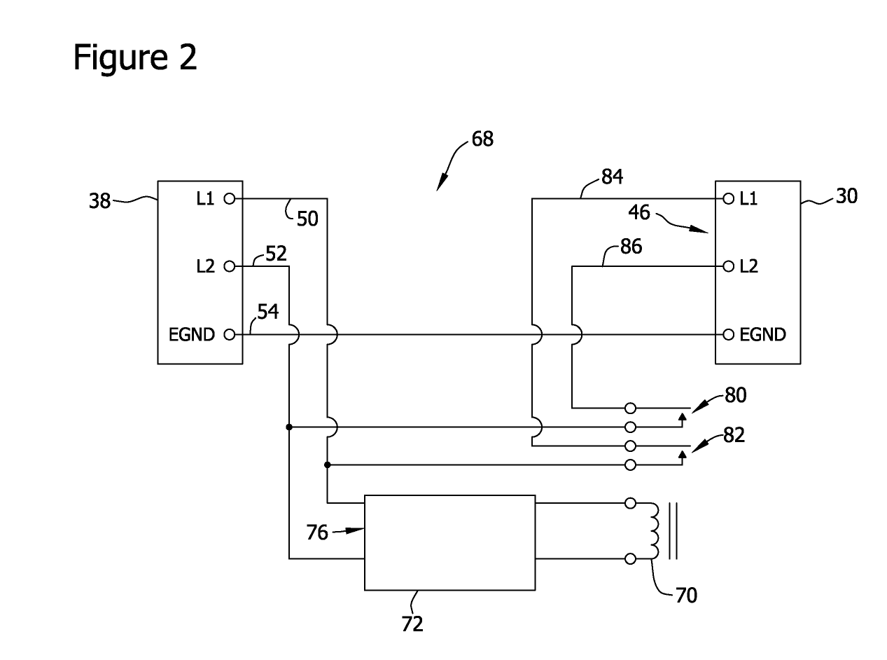

FIG. 2 is a block diagram of an exemplary embodiment of a filter circuit 68 that may be included within motor control system 10 (shown in FIG. 1). In the exemplary embodiment, filter circuit 68 includes at least one filter capacitor (not shown in FIG. 2) and a switching device 70 that selectively couples power supply 38 to motor controller 30. In the embodiment illustrated in FIG. 2, the at least one filter capacitor is included within motor controller 30. Switching device 70 may include, or may be coupled to, a power conditioning device 72. Switching device 70 may include, but is not limited to, a relay. In the exemplary embodiment, line conductor 50 and line conductor 52 of power supply 38 are coupled to an input 76 of power conditioning device 72. Power conditioning device 72 reduces a voltage level of power received from line conductors 50 and 52 to a level usable to drive switching device 70.

In the exemplary embodiment, switching device 70 includes a first set of connectors 80 and a second set of connectors 82. First and second set of connectors 80 and 82 are open when switching device 70 is not energized. More specifically, first and second set of connectors 80 and 82 are open when at least one of line conductor 50 and line conductor 52 is not providing switching device 70 with power. Conversely, when power is received at switching device 70 from both line conductor 50 and line conductor 52, switching device 70 is energized, and first and second set of connectors 80 and 82 are closed. Motor controller 30 causes motor 32 (shown in FIG. 1) to rotate when power is received at a line conductor 84 and a line conductor 86 of motor controller input 46. Therefore, when power is provided to line conductors 50 and 52, which corresponds to a signal to operate electric motor 32, connectors 80 and 82 are closed, which allows power to reach input 46 of motor controller 30.

As described above, in the exemplary embodiment, motor controller 30 includes at least one filter capacitor to shunt EMI voltages to ground conductor 54. When line conductor 84 and line conductor 86 are provided with power (e.g., each conductor 84 and 86 is provided with 120 VAC, 180 degrees out of phase from the voltage provided to the other conductor), dV/dt currents that flow through the at least one filter capacitor cancel out. Therefore, a resulting earth ground leakage current is approximately zero. However, if only one of conductor 84 and 86 is provided with power, there is a net current that flows through the at least one filter capacitor to ground conductor 54. This net current may exceed predefined limits, for example, ground leakage current limits defined by a standards organization such as Underwriters Laboratory (UL). For example, UL Standards that may be applicable include, but are not limited to, UL Standard Numbers 101, 1563, and/or 1081. As described above, switching device 70 prevents power from reaching motor controller input 46 if power is not present at both line conductor 50 and line conductor 52. Therefore, power is only provided to motor controller 30 when motor 32 is to be operated. Since no power is provided to the at least one filter capacitor when power is only present at one of line conductors 50 and 52, the ground leakage current through the filter capacitor is zero.

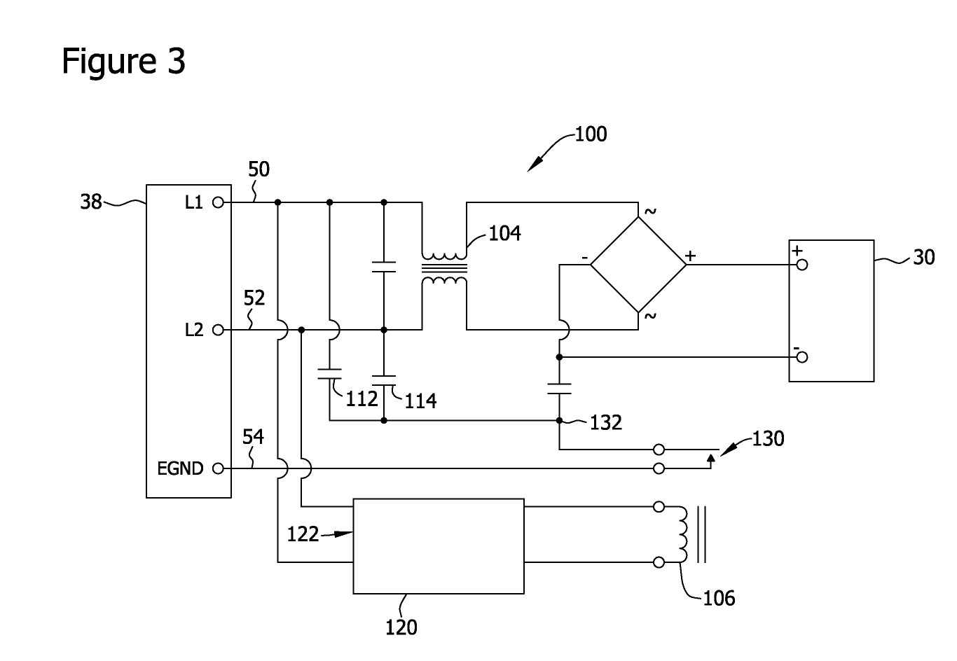

FIG. 3 is a circuit diagram of a first alternative filter circuit 100 that may be included within motor control system 10 (shown in FIG. 1). Filter circuit 100 selectively couples at least one filter capacitor to a ground conductor. More specifically, in the alternative embodiment, filter circuit 100 includes a common mode inductor 104, also referred to as a common mode choke, a switching device 106, and at least one filter capacitor, for example, but not limited to, a first filter capacitor 112 and a second filter capacitor 114, which may also be referred to as Y-caps. In the first alternative embodiment, common mode choke 104 is coupled between filter capacitors 112 and 114 and motor controller 30. Filter circuit 100 may also be referred to as an electromagnetic interference (EMI) filter. Filter circuit 100 is configured to suppress electromagnetic interference.

As described above with respect to switching device 70, switching device 106 may include, or may be coupled to, a power conditioning device 120. Switching device 106 may include, but is not limited to, a relay. In the first alternative embodiment, line conductor 50 and line conductor 52 of power supply 38 are coupled to an input 122 of power conditioning device 120. Power conditioning device 120 reduces a voltage level of power received from line conductors 50 and 52 to a level usable to drive switching device 106.

In the first alternative embodiment, switching device 106 includes a first set of connectors 130. First set of connectors 130 are open when switching device 106 is not energized. More specifically, first set of connectors 130 is open when at least one of line conductor 50 and line conductor 52 is not providing switching device 106 with power. Conversely, when power is received at switching device 106 from both line conductor 50 and line conductor 52, switching device 106 is energized, and first set of connectors 130 are closed. When first set of connectors 130 are closed, a ground side 132 of filter capacitors 112 and 114 is coupled to ground conductor 54.

Switching device 106 disconnects filter capacitors 112 and 114 from ground conductor 54 if power is not present at both line conductor 50 and line conductor 52. Therefore, filter capacitors 112 and 114 are only coupled to ground conductor 54 when motor 32 is to be operated. Ground leakage currents are prevented by disconnecting filter capacitors 112 and 114 from ground conductor 54 when an imbalance between the power at line conductor 50 and the power at line conductor 52 may cause high ground leakage currents. In comparison to the current flowing through switching device 70 (shown in FIG. 2, i.e., the total power provided to motor 32 for operation of motor 32), the current flowing through switching device 106 (i.e., only the ground leakage current from filter capacitors 112 and 114) is lower. Therefore, switching device 106 may be rated to handle a lower current level than switching device 70.

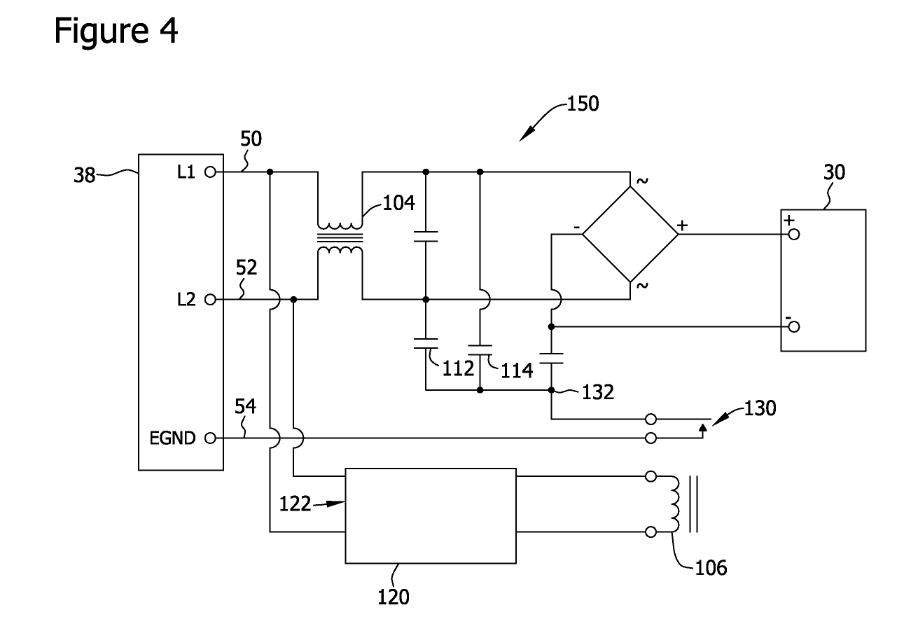

FIG. 4 is a circuit diagram of a second alternative filter circuit 150 that may be included within motor control system 10 (shown in FIG. 1). Filter circuit 150 selectively couples at least one filter capacitor to a ground conductor. More specifically, in the second alternative embodiment, filter circuit 150 includes common mode choke 104, switching device 106, and at least one filter capacitor, for example, but not limited to, first filter capacitor 112 and second filter capacitor 114. In the second alternative embodiment, common mode choke 104 is coupled between power supply 38 and filter capacitors 112 and 114.

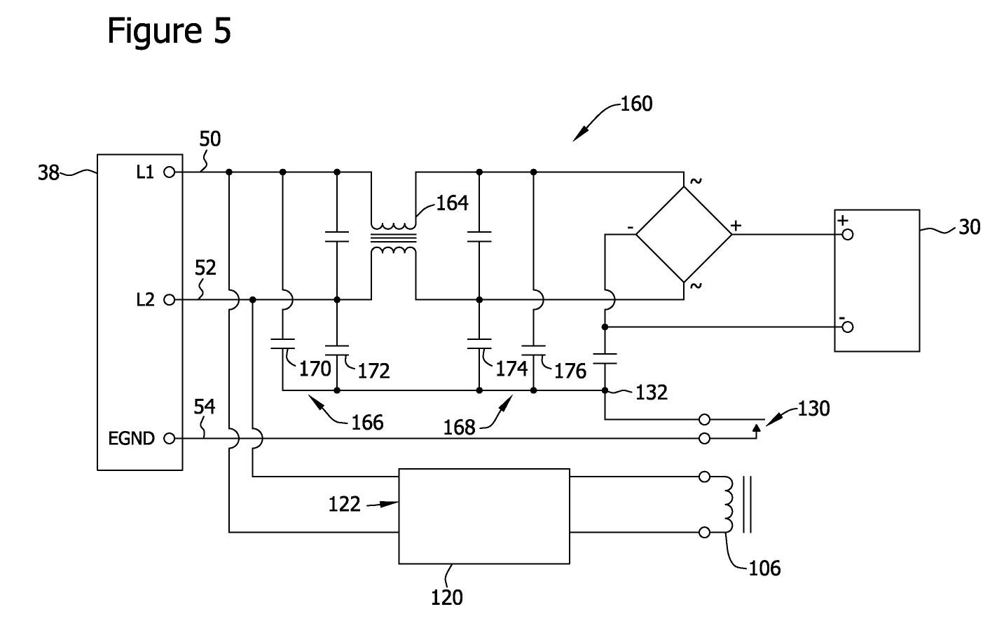

FIG. 5 is a circuit diagram of a third alternative filter circuit 160 that may be included within motor control system 10 (shown in FIG. 1). As described above with respect to filter circuit 100 and filter circuit 150, filter circuit 160 selectively couples at least one filter capacitor to a ground conductor. More specifically, in the third alternative embodiment, filter circuit 160 includes a common mode choke 164, switching device 106, and at least one filter capacitor. In the third alternative embodiment, filter circuit 160 includes a first set of filter capacitors 166 and a second set of filter capacitors 168. As illustrated, first set of filter capacitors 166 includes a first filter capacitor 170 and a second filter capacitor 172 and second set of filter capacitors 168 includes a third filter capacitor 174 and a fourth filter capacitor 176. However, sets of filter capacitors 166 and 168 may include any number of filter capacitors, including, but not limited to a single filter capacitor, that allows filter circuit 160 to function as described herein. In the third alternative embodiment, first set of filter capacitors 166 is coupled between power supply 38 and common mode choke 164 and second set of filter capacitors 168 is coupled between common mode choke 164 and motor controller 30.

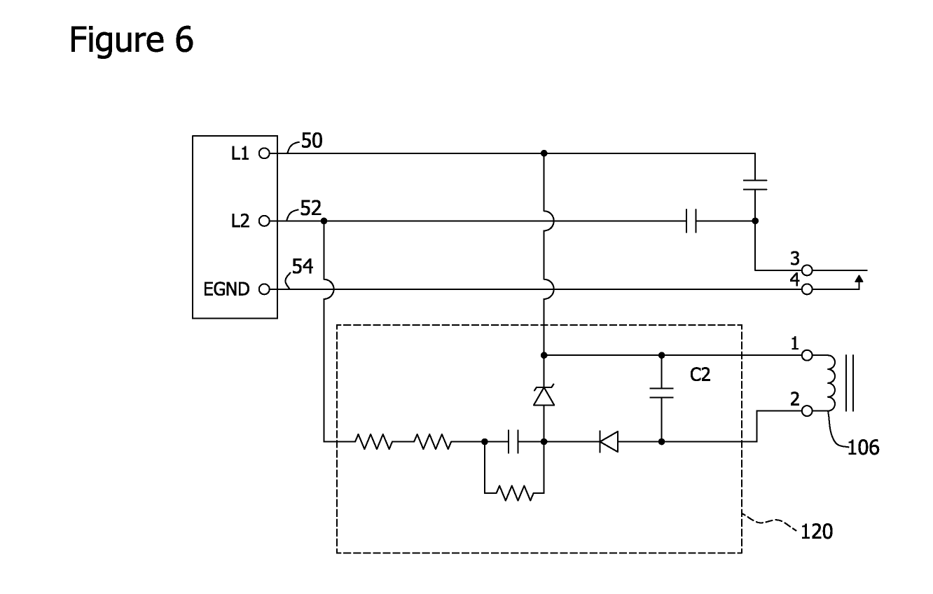

FIG. 6 is an exemplary circuit diagram of power conditioning device 120 and switching device 106 that may be included within motor control system 10 (shown in FIG. 1), for example, within filter circuit 100 (shown in FIG. 3), filter circuit 150 (shown in FIG. 4), and/or filter circuit 160 (shown in FIG. 5). As described above, power conditioning device 120 reduces a voltage level of power received from line conductors 50 and 52 to a level usable to drive switching device 106. For example, power conditioning device 120 may reduce power provided by power supply 38 at 120 volts to 24 volts for operating switching device 106. Alternatively, power conditioning device 120 may be configured to operate switching devices 106 having an input voltage (i.e., control signal) from approximately 5 volts to 48 volts.

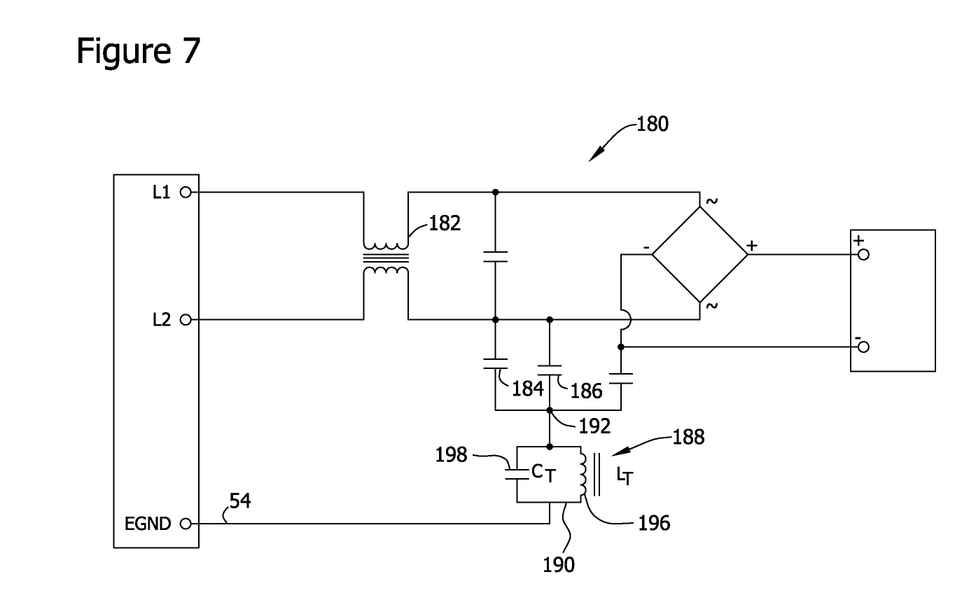

FIG. 7 is a circuit diagram of a fourth alternative filter circuit 180 that may be included within motor control system 10 (shown in FIG. 1). In the fourth alternative embodiment, filter circuit 180 includes a common mode choke 182, at least one filter capacitor, for example, a first filter capacitor 184 and a second filter capacitor 186, and a switching device 188. In the fourth alternative filter circuit 180, switching device 188 comprises an LC circuit 190, which may also be referred to as a resonant trap circuit, positioned between a ground side 192 of first and second filter capacitors 184 and 186 and ground conductor 54. Resonant trap circuit 190 includes an inductor 196 and a capacitor 198 and allows EMI currents to pass to ground conductor 54 while blocking leakage current. In a specific example, when ground leakage current is know to be 60 hertz, resonant trap circuit 190 is configured such that an impedance of resonant trap circuit 190 approaches infinity at approximately 60 hertz, which prevents the ground leakage current from reaching ground conductor 54. Conversely, since the frequency of EMI currents are much higher than 60 hertz, EMI currents pass through resonant trap circuit 190 unimpeded.

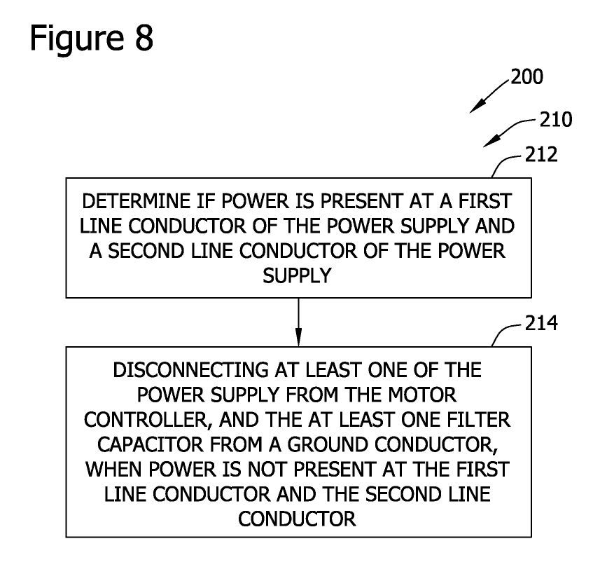

FIG. 8 is a flow chart 200 of an exemplary method 210 for reducing leakage current in a motor control system, for example, motor control system 10 (shown in FIG. 1). As described above, motor control system 10 includes a power supply 38 and a motor controller 30. In the exemplary embodiment, method 210 includes determining 212 if power is present at a first line conductor, for example, first line conductor 50 (shown in FIG. 1) and a second line conductor, for example, second line conductor 52 (shown in FIG. 1) of power supply 38. In the exemplary embodiment, method 210 also includes disconnecting 214 at least one of power supply 38 from motor controller 30, and at least one filter capacitor, for example, filter capacitors 112 and 114 (shown in FIG. 3) from a ground conductor, for example, ground conductor 54 (shown in FIG. 3) when power is not present at first line conductor 50 and second line conductor 52.

Disconnecting 214 power supply 38 from motor controller 30 may include operating a switching device, for example, switching device 70 (shown in FIG. 2) to disconnect power supply 38 from motor controller 30 when no current is flowing through at least one of first line conductor 50 and second line conductor 52. Furthermore, determining 212 if power is present at first line conductor 50 and second line conductor 52 may include energizing switching device 70 using power from power supply 38 when power is present at first line conductor 50 and second line conductor 52. Although described as determining 212 if power is present at first and second line conductors 50 and 52 by configuring switching device 70 to only energize when provided with power from both line conductor 50 and 52, it may be determined 212 whether current is present in line conductor 50 and/or 52 using, for example only, an eddy current device, a current transistor (CT) sensor, and/or any other device suitable for detecting the presence of current and/or power.

Described herein are exemplary methods, systems, and apparatus for reducing a ground leakage current flowing through an EMI filter circuit while also providing EMI protection to the motor drive controller. The leakage current is reduced or eliminated by either disconnecting the motor drive controller from a power source or disconnecting a ground of the filter circuit from earth ground when a current imbalance within line conductors may cause a ground leakage current.

The methods, systems, and apparatus described herein facilitate efficient and economical ground fault leakage current reduction in a variable speed drive. Exemplary embodiments of methods, systems, and apparatus are described and/or illustrated herein in detail. The methods, systems, and apparatus are not limited to the specific embodiments described herein, but rather, components of each system and/or apparatus, as well as steps of each method, may be utilized independently and separately from other components and steps described herein. Each component, and each method step, can also be used in combination with other components and/or method steps.

When introducing elements/components/etc. of the methods and apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A filter circuit configured for coupling a power supply and a motor controller, said filter circuit comprising:
at least one filter capacitor positioned between the power supply and the motor controller; and
at least one switching device coupled to the power supply and configured to selectively couple the power supply to the motor controller and/or the at least one filter capacitor to a ground conductor.

2. A circuit in accordance with claim 1, further comprising a common mode choke positioned between the power supply and the motor controller.

3. A circuit in accordance with claim 2, wherein said common mode choke is coupled between said at least one filter capacitor and the motor controller.

4. A circuit in accordance with claim 2, wherein said common mode choke is coupled between the power supply and said at least one filter capacitor.

5. A circuit in accordance with claim 2, wherein said at least one filter capacitor comprises a first set of filter capacitors and a second set of filter capacitors, wherein said first set of filter capacitors is coupled between the power supply and said common mode choke and said second set of filter capacitors is coupled between said common mode choke and the motor controller.

6. A circuit in accordance with claim 1, wherein said switching device comprises a relay coupled to the power supply and configured to couple the power supply and the motor controller when power is present at a first line conductor of the power supply and a second line conductor of the power supply.

7. A circuit in accordance with claim 6, wherein said relay comprises at least one set of connectors that are closed when power is present at the first line conductor and the second line conductor, and are open when power is not present at both of the first line conductor and the second line conductor.

8. A circuit in accordance with claim 1, wherein said switching device comprises a resonant circuit configured to prevent leakage current from reaching the ground conductor.

9. An electric motor configured to be powered by a power supply, said motor comprising:
a motor controller; and
a filter circuit coupled between the power supply and said motor controller, said filter circuit comprising at least one filter capacitor and configured to selectively couple the power supply to said motor controller and/or the at least one filter capacitor to a ground conductor.

10. A motor in accordance with claim 9, wherein said filter circuit comprises at least one switching device.

11. A motor in accordance with claim 10, wherein said at least one switching device comprises a relay coupled to the power supply and configured to couple the power supply and said motor controller when power is present at a first line conductor of the power supply and a second line conductor of the power supply.

12. A motor in accordance with claim 11, wherein said relay comprises at least one set of connectors that are closed when power is present at the first line conductor and the second line conductor, and are open when power is not present at both the first line conductor and the second line conductor.

13. A motor in accordance with claim 10, wherein said filter circuit further comprises a common mode choke positioned between the power supply and said motor controller.

14. A motor in accordance with claim 13, wherein said common mode choke is coupled between said at least one filter capacitor and said motor controller.

15. A motor in accordance with claim 13, wherein said common mode choke is coupled between the power supply and said at least one filter capacitor.

16. A motor in accordance with claim 13, wherein said at least one filter capacitor comprises a first set of filter capacitors and a second set of filter capacitors, wherein said first set of filter capacitors is coupled between the power supply and said common mode choke and said second set of filter capacitors is coupled between said common mode choke and said motor controller.

17. A motor in accordance with claim 9, wherein said switching device comprises a resonant circuit configured to prevent leakage current from reaching the ground conductor.

18. A method for reducing leakage current in an electric motor system that includes a power supply, at least one filter capacitor, and an electric motor, said method comprising:
determining if power is present at a first line conductor of the power supply and a second line conductor of the power supply; and
disconnecting at least one of the power supply from the motor controller, and the at least one filter capacitor from a ground conductor, when power is not present at the first line conductor and the second line conductor.

19. A method in accordance with claim 18, wherein disconnecting the power supply from the motor controller comprises operating a switching device to disconnect the power supply from the motor controller when current is not flowing through both the first line conductor and the second line conductor.

20. A method in accordance with claim 18, wherein determining if power is present at the first line conductor and the second line conductor comprises energizing the switching device using power from the power supply when power is present at the first line conductor and the second line conductor.
